(19) United States
(12) Patent Application Publication
(10) Pub. No.: US 2011/0250501 A1
(43) Pub. Date: Oct. 13, 2011

(54) NEGATIVE ELECTRODE FOR LITHIUM ION SECONDARY BATTERY AND LITHIUM ION SECONDARY BATTERY

(76) Inventors: Noriyuki Uchida, Osaka (JP); Noriaki Amo, Hyogo (JP); Daisuke Suetsugu, Osaka (JP)

(21) Appl. No.: 13/140,706

(22) PCT Filed: Sep. 27, 2010
(86) PCT No.: PCT/JP2010/005789

§ 371 Date: Jun. 17, 2011

(30) Foreign Application Priority Data
Jul. 10, 2009 (JP) 2009-233116

(51) Int. Cl. H01M 4/70

(52) U.S. Cl. 429/239

(57) ABSTRACT

A lithium ion secondary having a high capacity in which decrease in the cycle characteristics is suppressed is provided by reducing cracks formed by repetition of charge and discharge. A negative electrode for a lithium ion secondary battery, including: a current collector sheet and a negative electrode active material layer supported on the current collector sheet; the current collector sheet including protruding portions arranged according to a regular pattern and flat portions existing between the protruding portions, wherein the negative electrode active material layer includes columnar bodies having a roughly spindle shape supported on the protruding portions, and bumps supported on the flat portions, the columnar bodies and the bumps are composed of an alloy-based negative electrode active material, the bumps have a height lower than a height of a position in which the columnar bodies adjacent to each other are the closest to each other, and in a vertical cross section made by supposedly cutting from a supposed straight line passing through each center of two adjacent columnar bodies and a center of the bump sandwiched between the columnar bodies toward a surface of the current collector sheet, a sectional area of the bump accounts for 25% or more, on average, of a sectional area of a space defined by a line segment connecting positions in which the two adjacent columnar bodies are the closest to each other, a surface of the flat portion, and two side surfaces of the two columnar bodies.

### TECHNICAL FIELD

The present invention relates to a negative electrode for a lithium ion secondary battery and a lithium ion secondary battery using the same. Specifically, the present invention relates to an improvement in the negative electrode using an alloy-based active material.

### BACKGROUND ART

In recent years, there has been an increasing demand for batteries used for portable devices such as portable computers and cellular phones. Batteries for portable devices are required to have a high capacity, a high energy density, and excellent cycle characteristics. Lithium ion secondary batteries satisfy these requirements.

A lithium ion secondary battery includes positive and negative electrodes absorbing and desorbing lithium ions, a separator separating the positive electrode and the negative electrode, and an electrolyte having a lithium ion conductivity. The negative electrode is generally formed of a negative electrode current collector such as a copper foil and a negative electrode active material layer supported on the negative electrode current collector. As a negative electrode active material included in the negative electrode active material layer, carbonaceous negative electrode active material such as graphite has conventionally been used. In recent years, so-called alloy-based negative electrode active material has been known as the negative electrode active material having a higher capacity and a higher energy density than carbonaceous negative electrode active material. Examples of the alloy-based negative electrode active material include simple substance, oxides, or alloys of silicon or tin. During the charge and discharge of a lithium ion secondary battery, the alloy-based negative electrode active material absorbs or desorbs lithium ions reversibly. The alloy-based negative electrode active material expands by absorbing lithium ions and alloying with lithium, and shrinks by desorbing lithium ions and dealloying.

The negative electrode active material expands notably by absorbing lithium ions. The expansion ratio of the alloy-based negative electrode active material by absorbing lithium ions is significantly higher than the expansion ratio of the carbonaceous negative electrode active material. During the charge, the negative electrode current collector itself cannot deform by following sufficiently the significant expansion of the alloy-based negative electrode active material. Consequently, during the charge, the negative electrode current collector may be damaged partly, or the negative electrode active material layer may separate partly from the negative electrode current collector. In such a case, a gap is created between the negative electrode current collector and the negative electrode active material layer to lower the electrical conductivity between the negative electrode current collector and the negative electrode active material layer, which may result in deterioration in the charge and discharge characteristics. Also, when the charge and discharge are repeated, the current collector may have creases, winding, or distortion. In such a case, a gap is created between the separator and the current collector or between the current collector and the positive electrode to make the charge and discharge reactions uneven in the battery, which may result in local deterioration in the battery characteristics.

In order to relax internal stress of the alloy-based active material produced during expansion, a negative electrode in which space is created inside the negative electrode active material layer is known. Specifically, for example, Patent Literature 1 as below discloses forming columnar protruding portions of silicon by forming a silicon thin film on a flat surface of the negative electrode current collector and removing partly the formed silicon thin film. Patent Literature 1 discloses that, in such a negative electrode, it is possible to form space between adjacent columnar protruding portions of silicon, and consequently, it is possible to relax internal stress of the alloy-based active material produced during expansion and suppress occurrence of creases etc.

### CITATION LIST

### Patent Literature

[PTL 1] Japanese Laid-Open Patent Publication No. 2003-303586

### SUMMARY OF INVENTION

### Technical Problem

In the electrode disclosed in Patent Literature 1, columnar-shaped silicon is formed on a flat surface of a current collector with a foundation layer interposed therebetween. Such columnar-shaped silicon expands notably by absorbing lithium ions from the positive electrode along with the charge. Then, excessively expanded silicon cannot stand further expansion and cracks are produced. A surface exposed by the cracks has a high activity and decomposes the electrolyte. Consequently, such occurrence of cracks results in deterioration in the cycle characteristics.

The present invention has an object to provide a lithium ion secondary battery with a high capacity using an alloy-based active material with a high capacity in which deterioration in the cycle characteristics is suppressed by reducing occurrence of cracks caused by repetition of the charge and discharge.

### Solution to Problem

A negative electrode for a lithium ion secondary battery in accordance with an aspect of the present invention includes a current collector sheet and a negative electrode active material layer supported on the current collector sheet, the current collector sheet including a surface that comprises a plurality of protruding portions arranged according to a pattern having regular intervals and a plurality of flat portions existing between the plurality of protruding portions, wherein the negative electrode active material layer includes a plurality of columnar bodies having a roughly spindle shape, each of the columnar bodies supported on each of the protruding portions, and a plurality of bumps, each of the bumps supported on each of the flat portions, the columnar bodies and the bumps comprising an alloy-based negative electrode active material, the bumps have a height lower than a height of a position in which the columnar bodies adjacent to each other are the closest to each other, and in a discharged state of the lithium ion secondary battery, in a vertical cross section made by supposedly cutting from a supposed straight line passing through each center of two adjacent columnar bodies and a center of the bump sandwiched between the two columnar bodies when viewed on an upper surface toward a surface of the current collector sheet, a sectional area of the bump accounts for 25% or more, on average, of a sectional area of a space defined by a line segment connecting positions in which the two adjacent columnar bodies are the closest to each other, a surface of the flat portion, and two side surfaces of the columnar bodies.

By using such a negative electrode for a lithium ion secondary battery, the columnar bodies and the bumps expanded during the charge of the battery come in contact with each other, and therefore internal stress produced in the negative electrode active material layer is dispersed and expansion of the negative electrode active material is restricted. Consequently, occurrence of cracks in the negative electrode active material can be suppressed. Also, the bumps arranged in space formed between the plurality of columnar bodies contribute to secure the battery capacity. Therefore, in case the alloy-based negative electrode active material of the same amount is carried on the current collector, space can be utilized effectively. Therefore, concentration of internal stress produced in the negative electrode active material layer can be suppressed.

A lithium ion secondary battery in accordance with another aspect of the present invention includes the negative electrode for a lithium ion secondary battery, a positive electrode absorbing and desorbing lithium ions, a separator separating the negative electrode and the positive electrode, and an electrolyte having a lithium ion conductivity.

Such a lithium ion secondary battery has a high capacity and excellent cycle characteristics.

### Advantageous Effects of Invention

According to the present invention, a lithium ion secondary battery having a high capacity and excellent cycle characteristics can be provided.

### BRIEF DESCRIPTION OF DRAWINGS

FIG. 1

A schematic view of an upper surface of a negative electrode for a lithium ion secondary battery in accordance with an embodiment of the present invention.

FIG. 2

A schematic sectional view taken by line II-II of FIG. 1.

FIG. 3

A schematic vertical sectional view of a surface of a negative electrode 10 during the charge of a lithium ion secondary battery.

FIG. 4

A schematic diagram illustrating an example of a vapor deposition apparatus for forming a negative electrode active material layer.

FIG. 5

A diagram illustrating formation of bumps.

FIG. 6

A vertical sectional view of a laminate type lithium ion secondary battery in accordance with an embodiment of the present invention.

### DESCRIPTION OF EMBODIMENTS

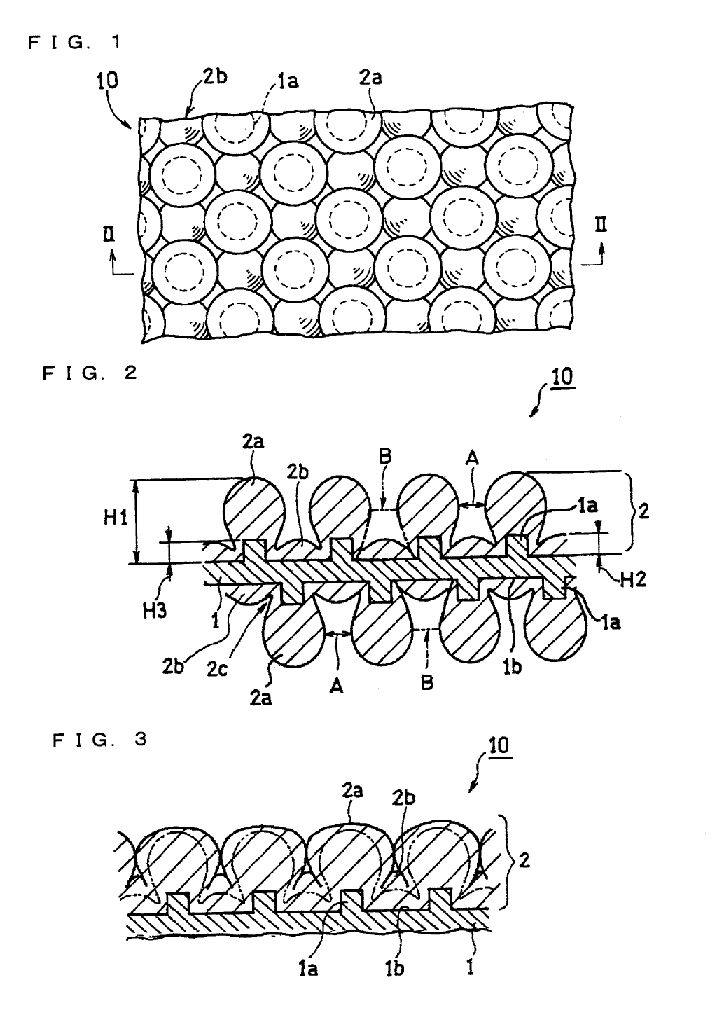

A negative electrode 10 for a lithium ion secondary battery in accordance with the present embodiment is described in detail by referring to drawings. FIG. 1 is a schematic top view of a surface of the negative electrode 10. FIG. 2 is a schematic vertical sectional view taken by line II-II of FIG. 1. FIG. 3 is a schematic sectional view of a surface of the negative electrode 10 during the charge of the lithium ion secondary battery (also referred to simply as the battery, hereinafter). The negative electrode 10 includes a negative electrode current collector 1 and a negative electrode active material layer 2 supported on both surfaces of the negative electrode current collector 1. As shown in FIG. 2, the negative electrode current collector 1 is a metal sheet that includes, on both surfaces thereof, a plurality of protruding portions 1a having a height H3 arranged according to a pattern having regular intervals, and also flat portions 1b between the protruding portions 1a. The negative electrode active material layer 2 is composed of an alloy-based negative electrode active material (also referred to simply as a negative electrode active material, hereinafter) that absorbs and desorbs lithium ions. The negative electrode active material layer 2 includes columnar bodies 2a with a height H1 having a roughly spindle shape that are supported on the protruding portions 1a of the current collector 1, and bumps 2b with a height H2 having a raising middle portion that are supported on the flat portions 1b of the current collector 1. FIGS. 1 and 2 show the state of the negative electrode active material layer 2 in the discharged state.

As the alloy-based negative electrode active material, conventionally known materials that form an alloy with lithium ions such as simple substance, oxides, and alloys of silicon or tin can be used without particular restriction. Among these materials, silicon oxide represented by SiOₓ (0≦x≦1.5) is particularly preferable in view of maintaining a high capacity. When x exceeds 1.5, the negative electrode active material layer 2 having a larger thickness should be formed in order to secure the capacity, and in this case, the negative electrode current collector 1 is likely to warp. x is more preferably 0.3 or more and 1.2 or less. When x is 0.3 or more, expansion and contraction of the negative electrode active material along with the charge and discharge are smaller than the case of using silicon simple substance, and therefore stress change caused during expansion and contraction can be reduced.

As shown in FIGS. 1 and 2, the bumps 2b exist on the surface of the flat portions 1b sandwiched between the adjacent columnar bodies 2a. In a supposed vertical sectional view made by cutting vertically with a straight line passing through the center of a bump 2b and each center of two columnar bodies 2a adjacent to the bump 2b when the negative electrode 10 is viewed on an upper surface, the bump 2b exists in a space B defined by a line segment A connecting positions in which the columnar bodies 2a are the closest to each other, the surface of the flat portion 1b, and side surfaces of the two columnar bodies 2a. In FIG. 2, the space B is an area surrounded by a broken line. In the discharged state, the sectional area of the bump 2b accounts for 25% or more of the sectional area of the space B. Herein, the “discharged state” means a discharged state in the charge and discharge period in the initial use (break-in charge and discharge) of the lithium ion secondary battery in which the negative electrode 10 is incorporated. The ratio of the sectional area of the bump 2b relative to the sectional area of the space B is determined by removing the negative electrode 10 from the lithium ion secondary battery in the discharged state, photographing an image of a selected cross section of the negative electrode 10 or an image of a face observed from the horizontal direction with a scanning electron microscope (SME), measuring the sectional area of the space B and the sectional area of the bump 2b, and calculating the percentage of the sectional area of the bump 2b relative to the sectional area of the space B.

In the negative electrode 10, the bumps 2b composed of a negative electrode active material contributing to the charge and discharge reactions are formed in the space formed between the plurality of columnar bodies 2a. In the negative electrode active material layer 2 including such bumps 2b, during expansion of the negative electrode active material, as shown in FIG. 3, expanded bumps 2b are in contact with expanded columnar bodies 2a, and thus internal stress produced in the negative electrode active material layer 2 is dispersed. During the charge of the battery, the columnar bodies 2a and the bumps 2b are expanded by adsorbing lithium ions. Then, the expanded columnar bodies 2a are in contact with and supported by the expanded bumps 2b. Consequently, expansion of the negative electrode active material layer 2 caused by internal stress produced by expansion is limited. As a result, when the charge and discharge of the battery are repeated, occurrence of cracks by excessive expansion of the negative electrode active material, damage to the negative electrode current collector, and separation of the negative electrode active material from the negative electrode current collector are suppressed. Therefore, the cycle characteristics are improved. Further, by arranging the bumps 2 contributing to securing the capacity in the space between the adjacent columnar bodies 2a, a higher capacity can be secured.

The percentage of the sectional area of the bumps 2b in the sectional area of the space B is 25% or more, preferably 30 to 60%, and more preferably 30 to 40%. When the percentage of the sectional area of the bumps 2b in the sectional area of the space B is less than 25%, contribution of the bumps 2b for securing the capacity is decreased, or cracks may be formed by excessive expansion of the negative electrode active material. Meanwhile, although the upper limit of the percentage of the area of the bumps 2b in the area of the space B is not particularly limited, when the percentage is too high, the effect of relaxing stress by the space existing between the columnar bodies 2a tends to decrease.

Herein, a method of determining the percentage of the area of the bumps 2b in that of the space B is described in detail. First, a lithium ion secondary battery in which the negative electrode 10 in the initial use period is incorporated is charged. As for the charge, for example, a constant current charge is carried out in an environment at 20° C. at a charge rate of 1 C until the battery voltage reaches 4.2 V, and subsequently, a constant voltage charge is carried out until the current value reaches 0.05 C. Then, the charged lithium ion secondary battery is discharged. As for the discharge, a constant current discharge is carried out at a discharge rate of 0.2 C until the battery voltage reaches 2.5 V. Such a state after the constant current discharge in the initial use period of the lithium ion secondary battery is referred to as an “initial discharged state”.

Next, an electrode plate group including the negative electrode 10 is removed from the lithium ion secondary battery in the initial discharged state. Then, the negative electrode 10 is removed from the removed electrode plate group. Subsequently, a selected cross section or a horizontal face of the obtained negative electrode 10 is observed by a magnification of 2,000, for example, with a scanning electron microscope (SEM). Thereafter, in an obtained SEM image, a line segment A connecting positions in which two columnar bodies 2a are the closest to each other is drawn. Then, the sectional area of the space B that is an area surrounded by the line segment A, the surface of the flat portion 1b, and the side surfaces of the columnar bodies 2a is measured. In the same manner, in the same SEM image, the sectional area of the bump 2b existing in the space B is measured. Subsequently, the occupied percentage of the sectional area of the bump 2b in the measured sectional area of the space B is calculated. The percentage of the sectional area of the bumps 2b in the sectional area of the space B is calculated at five points, for example, and an average value of the percentages at these points is calculated. Thus, the occupied percentage of the sectional area of the bumps 2b in the sectional area of the space B in the negative electrode 10 in the initial discharged state is calculated.

The cross section of the columnar bodies 2a in the discharged state has a roughly spindle shape in which side surfaces are swelling partly, and preferably a roughly spindle shape in which the upper side is more swelling than the central portion. Then, the height H1 of the columnar bodies 2a, which is defined as the height from the flat portions 1b of the negative electrode current collector to the top portion of the columnar bodies 2a, is preferably about 20 to 30 μm, and preferably 22 to 24 μm. When the height H1 of the columnar bodies 2a is too high, the expanded columnar bodies 2a are closely contacted to each other, and thus expansion is limited between the columnar bodies 2a. However, in this case, since the space B is extended in the vertical direction, the contact area of the bumps 2b and the columnar bodies 2a is reduced, and as a result, expansion of the lower portions of the columnar bodies 2a cannot be limited easily. Also, when H1 is too low, the space B is extended in the horizontal direction, and as a result, the contact area of the bumps 2b and the columnar bodies 2a tends to increase. However, since the expanded columnar bodies 2a cannot easily contact closely to each other, expansion cannot be limited easily by the contact of the columnar bodies 2a with each other.

The height H2 of the top portions of the bumps 2b in the discharged state, which is defined as the height from the surface of the flat portions 1b of the negative electrode current collector 1 to the top portion of the bumps 2b, is preferably about 3 to 6 μm, and more preferably 3 to 4 μm.

The height H2 of the top portions of the bumps 2b in the discharged state preferably accounts for 10 to 30%, more preferably 10 to 25% of the height H1 of the top portions of the columnar bodies 2a. When the percentage of the height H2 of the top portions of the bumps 2b is too low relative to the height H1 of the top portions of the columnar bodies 2a, the effect of securing the capacity by the bumps 2b decreases, and also the effect of limiting expansion by the contact with the columnar bodies 2a tends to decrease. Meanwhile, when the percentage of the height of the bumps 2b is too high, the effect of relaxing stress by the space existing between the columnar bodies 2a tends to decrease.

The bumps 2b in the discharged state have preferably a shape in which the middle portion thereof is more raising in a hill shape than the periphery thereof, because such a shape is in line with the shape of the lower portions of the columnar bodies having a roughly spindle shape. Then, the height of the top portions of the bumps 2b is preferably 1.3 times or more, more preferably 1.3 to 2.5 times as high as the height of the end portions 2c. When the bumps 2b have a shape in which the middle portions of the bumps 2b are raising such that the height of the top portions of the bumps 2b is 1.3 times or more as high as the height of the end portions 2c, the effect of dispersing stress between the columnar bodies 2a and the bumps 2b is preferably high.

The porosity of the negative electrode active material layer 2 in the initial discharged state is preferably 20 to 70%, more preferably 30 to 40%. When the porosity is too high, the density of the negative electrode active material tends to become small, and when the porosity is too low, the effect of relaxing stress by the space existing between the columnar bodies 2a tends to decrease. The porosity of the negative electrode active material layer 2 can be determined, for example, by measurement using a mercury porosimeter.

When the porosity of the negative electrode active material layer 2 is too high, the volume ratio of the bumps 2b in the negative electrode active material layer 2 tends to be low. That is, the bumps 2b having a volume sufficient to fully contribute for securing the capacity are not likely to be formed between the adjacent columnar bodies 2a. In contrast, when the porosity of the active material layer 2 is too low, the volume ratio of the bumps 2b in the negative electrode active material layer 2 tends to be high. In such a case, the effect of relaxing stress by the space existing between the columnar bodies 2a tends to decrease.

Next, an example of a method of producing the negative electrode 10 will be described in detail.

The negative electrode 10 is produced by growth forming the columnar bodies 2a and the bumps 2b while controlling growth speed of the alloy-based negative electrode active material on the protruding portions 1a and growth speed of the alloy-based negative electrode active material on the flat portions 1b shadowed by the protruding portions 1a at the time of coating the surface of the negative electrode current collector 1 including a plurality of protruding portions 1a and flat portions 2b arranged according to regular patterns with the alloy-based negative electrode active material by using a vapor phase thin film-forming method such as a vapor deposition process.

The negative electrode current collector 1 can be formed, for example, by pressing a sheet-shaped current collector material with steel rollers having depressed portions corresponding to the shape of the protruding portions 1a on the surface thereof.

Specific examples of the current collector material include a copper foil, a copper alloy foil, and a nickel foil. Specific examples of the copper alloy foil include a copper alloy foil including 0.2% by mass of chromium, tin, zinc, silicon, nickel etc., respectively, relative to copper, a copper alloy foil including 0.05 to 0.2% by mass of tin relative to copper, a copper foil including 0.02 to 0.2% by mass of zirconium relative to copper, and a copper alloy foil including 1 to 4% by mass of titanium relative to copper.

The height H3 of the protruding portions 1a is not particularly limited, but is preferably 3 to 15 μm, and more preferably 5 to 10 μm. When the height of the protruding portions 1a is too low, a shadowing effect by the protruding portions 1a, which is an effect of controlling vapor deposition speed at the time of vapor depositing the alloy-based negative electrode active material to the flat portions 1b by the protruding portions 1a, is difficult to exhibit, and therefore the alloy-based active material is growth formed excessively on the flat portions 1b. In such a case, space is not readily formed between the adjacent columnar bodies 2a. When the height of the protruding portions 1a is too high, the shadowing effect is too high, which makes the bumps 2b difficult to be formed on the surface of the flat portions 1b.

The shape of the protruding portions 1a is not particularly limited, and specific examples thereof include a columnar shape such as a rhombic-columnar shape, a cone shape, and a trapezoid shape. Among these shapes, the rhombic-columnar shape is preferable in view of readiness of processing.

Also, the regular arrangement pattern of the protruding portions 1a is not particularly limited, and specific examples thereof include a lattice alignment and a zigzag alignment. Among these alignment patterns, zigzag alignment is preferable in view of being excellent in stress relaxation because of having an appropriate porosity after vapor deposition.

The area percentage of the flat portions 1b relative to the surface area of the negative electrode current collector 1 is preferably 30 to 50%, and more preferably 30 to 35%. When the area percentage of the flat portions 1b is too low, sufficient space cannot be maintained between the adjacent columnar bodies 2a, and also the shadowing effect during the vapor deposition process, as describe later, becomes too high, which makes the bumps 2b difficult to be formed. In contrast, when the area percentage of the flat portion 1b is too high, space between the adjacent columnar bodies 2a is too large, and as a result, the shadowing effect during the vapor deposition process, as described later, is too low, which makes space difficult to be formed between the adjacent columnar bodies 2a.

The columnar bodies 2a and the bumps 2b can be growth formed by vapor depositing an alloy-based negative electrode active material source from an oblique direction to the surface of the negative electrode current collector 1 under predetermined conditions (also referred to as an oblique vapor deposition process, hereinafter). In this method, the flat portions 1b are shadowed by the protruding portions 1a during vapor deposition. Consequently, the growth speed of the alloy-based active material on the flat portions 1b is lower than the growth speed of the alloy-based active material on the protruding portions 1a. As a result, the columnar bodies 2a and the bumps 2b that are smaller than the columnar bodies 2a are formed. Since central portions between the adjacent protruding portions 1a are not likely to be shadowed as compared to the peripheries of the protruding portions 1a, the bumps 2b having a shape in which the middle portion is more raising than the periphery thereof are formed.

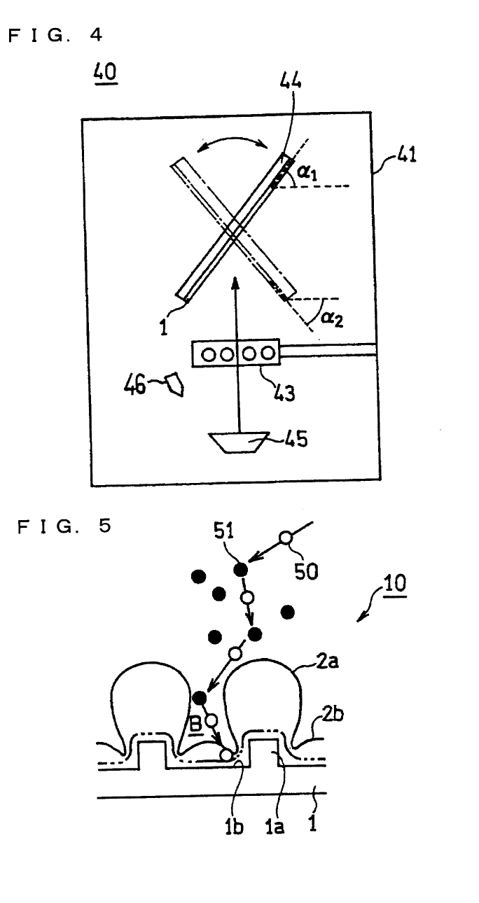

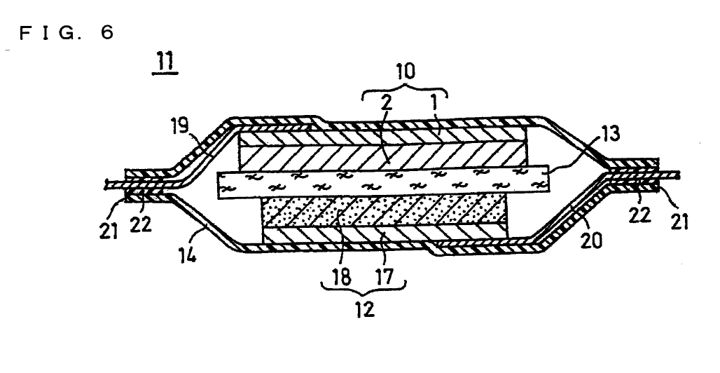

An oblique vapor deposition process is carried out, for example, by a multi-step vapor deposition of vapor depositing while changing the angle of the negative electrode current collector 1 to a target 45 by using a vapor deposition apparatus 40 as illustrated in FIG. 4.

The vapor deposition apparatus 40 includes a vacuum chamber 41, a nozzle 43 for supplying raw material gas etc., a fixture stand 44 for fixing the negative electrode current collector 1, a target 45, which is a vapor deposition source including silicon, tin, or oxides or alloys thereof, and an electron beam gun 46 for vaporizing the target. The fixture stand 44 is movable toward a direction as shown by an arrow in FIG. 4.

First, the negative electrode current collector 1 is fixed on the fixture stand 44. Herein, it is preferable that an angle α₁ between a horizontal direction and the fixture stand 44 is adjusted, for example, in the range of about 50 to 72°, and more preferably, about 60 to 65° such that the vapor from the target 45 comes in contact with the surface of the negative electrode current collector 1 from an oblique direction. Then, after an inside of the vacuum chamber 41 is decompressed by using an exhaust pump that is not shown in the figure, gas is supplied at a predetermined flow rate from the nozzle 43. Specific examples of the gas include a carrier gas that is an inert gas such as helium (He), argon (Ar), nitrogen in addition to raw material gas for forming silicon oxide such as oxygen. Subsequently, pressure inside the vacuum chamber 41 is adjusted to a predetermined pressure by a regulator that is not shown in the figure. Thereafter, an electron beam is applied to the target 45 while acceleration voltage of the electron beam gun 46 is adjusted, and thus the target 45 such as silicon is vaporized. Then, vaporized substance of the target 45 and raw material gas such as oxygen supplied from the nozzle 43 are vapor deposited on the surface of the negative electrode current collector 1. Such a vapor deposition process is carried out for a predetermined time. In this process, since the surface of the negative electrode current collector 1 is inclined with a certain degree with respect to the target 45, the flat portions 1b formed between the protruding portions 1a are partly shadowed with respect to the direction of the target 45. As a result, growth of the vapor deposited film on the side of one direction of the protruding portions 1a is accelerated, and growth of the vapor deposited film on the surface of the flat portions 1b, which are shadowed portions, is retarded. Such an effect of adjusting growth speed of the vapor deposited film by utilizing the shadow of the protruding portions 1a is called a shadowing effect. In this manner, a first-step vapor deposition is carried out.

In the above oblique vapor deposition process, it is preferable to increase collision frequency of raw material atoms 50 vaporized from the target 45 and gas 51 supplied from the nozzle 43 by increasing relatively the flow rate of the gas supplied from the nozzle 43, by increasing relatively pressure inside the vacuum chamber 41, or by changing appropriately acceleration voltage of the electron beam gun 46, for example. Consequently, an incident direction of the raw material atoms 50 vaporized from the target 45 with respect to the surface of the negative electrode current collector 1 can be varied, as shown in FIG. 5. As a result, the amount of the raw material atoms 50 and the gas 51 that deposit on the flat portions 1b shadowed by the protruding portions 1a can be adjusted. Therefore, growth speed of the columnar bodies 2a and the bumps 2b can be controlled more easily. As a specific example of conditions of such vapor deposition, after the inside of the vacuum chamber 41 is decompressed to 7×10⁻³ Pa (abs) or less, an inert gas is introduced to adjust pressure to about 1×10⁻² to 5×10⁻² Pa (abs). Under such conditions, collision frequency of molecules is increased, and therefore growth of vapor deposited film on the flat portions 1b can be accelerated.

Next, by moving the fixture stand 44 after the first-step vapor deposition, inclination of the surface of the negative electrode current collector 1 with respect to the target 45 is adjusted to angle α₂ formed with a horizontal direction. The angle α₂ is generally adjusted to −α₁ degree with respect to a horizontal direction in relation to angle α₁ adjusted in the first step. Then, a vapor deposition process is carried out under the same conditions as the first-step vapor deposition. Thus, a second-step vapor deposition is carried out.

By repeating the oblique vapor deposition from the side of angle α₁ and the oblique vapor deposition from the side of angle α₂ alternately for predetermined number of steps, the columnar bodies 2a and the bumps 2b are formed on the surface of the negative electrode current collector 1. Thus, the negative electrode 10 is produced.

Next, a laminate type lithium ion secondary battery 11 which is an example of a lithium ion secondary battery using the negative electrode 10 will be described by referring to FIG. 5.

The laminate type lithium ion secondary battery 11 includes an electrode group comprising the negative electrode 10, a positive electrode 12, and a separator 13 separating the negative electrode 10 and the positive electrode 12, and an electrolyte having a lithium ion conductivity. The electrode group and the electrolyte are housed in an outer case 14. The negative electrode 10 includes a negative electrode current collector 1 and the negative electrode active material layer 2 formed on the negative electrode current collector 1. The positive electrode 12 includes a positive electrode current collector 17 and a positive electrode active material layer 18 formed on the positive electrode current collector 17. An end of a negative electrode lead 19 is connected to the negative electrode current collector 1, and an end of a positive electrode lead 20 is connected to the positive electrode current collector 17. The other end of the negative electrode lead 19 and the other end of the positive electrode lead 20 are lead out of the outer case 14. The outer case 14 is a laminate film composed of resin films and an aluminum foil laminated therebetween, and an opening portion 21 thereof is sealed with a gasket 22 composed of a resin material.

The positive electrode 12 is produced, for example, by applying a positive electrode material mixture liquid prepared by dispersing a positive electrode active material, a conductive agent, a binder etc. in a dispersing medium onto a surface of a positive electrode current collector plate, and drying and rolling the same.

Specific examples of the positive electrode active material include composite oxides such as lithium cobaltate and modified lithium cobaltate (solid solution of lithium cobaltate in which aluminum or magnesium is dissolved), lithium nickelate and modified lithium nickelate (in which part of nickel is replaced with cobalt), and lithium manganate and modified lithium manganate. These materials can be used singly or in combination of two or more.

Specific examples of the conductive agent include carbon blacks such as acetylene black, ketjen black, channel black, furnace black, lump black, and thermal black, and a variety of graphite. Specific examples of the binder include polyvinylidene fluoride, polytetrafluoroethylene, and rubber particles having an acrylate unit. These materials can be used singly or in combination of two or more. The separator and the non-aqueous electrolyte used in this embodiment are not particularly limited, and a variety of materials known in this field can be used.

Next, the present invention will be described more specifically by referring to examples. It is to be noted that the scope of the present invention is not limited by the content of examples.

### EXAMPLES

### Example 1

### (1) Production of Negative Electrode Current Collector

A negative electrode current collector having protruding portions on both surfaces was produced by rolling a copper alloy foil with a pair of steel rollers, one of which having a plurality of circular depressed portions on the surface. As the copper alloy foil, a copper alloy foil having a thickness of 26 μm (Zr content 0.02% by mass, available from Hitachi Cable, Ltd.) was used. The linear pressure of the rolling was 1,000 kgf/cm (about 9.81 kN/cm).

On the surface of the negative electrode current collector, a plurality of columnar-shaped protruding portions arranged according to a zigzag alignment pattern was formed. Each of the protruding portions had a height of about 7 μm and a diameter of about 10 μm. The distance between the adjacent protruding portions was 30 μm. The area ratio of the flat portions of the negative electrode current collector was 30 to 40%.

### (2) Production of Negative Electrode

By using the vapor deposition apparatus 40 as illustrated in FIG. 4, a negative electrode active material layer composed of an alloy-based negative electrode active material was formed on both surfaces of the obtained negative electrode current collector.

Silicon having a 99.9999% purity was used for the target as the vapor deposition source. First, the obtained negative electrode current collector is disposed on the fixture stand 44 of the vapor deposition apparatus 40, and the angle α₁ between the surface of the negative electrode current collector and the horizontal direction was arranged to 60°. Next, pressure inside the vacuum chamber 41 was decompressed to 7×10⁻³ Pa (abs). Then, oxygen gas and He gas were supplied into the vacuum chamber 41 from the nozzle 43. The flow rate of the oxygen gas was set to 400 sccm (25° C.) and the flow rate of the He gas was set to 80 sccm (25° C.) Subsequently, pressure inside the vacuum chamber 41 was adjusted to 5×10⁻² Pa (abs) by adjusting the supply of gases and the regulator. Thereafter, an electron beam was applied to the target from the electron beam gun under conditions of acceleration voltage of −8 kV and emission of 500 mA, thereby to carry out the first-step vapor deposition. Vapor deposition time was five seconds. By this first-step vapor deposition, a silicon oxide layer having a thickness of 80 nm was formed on the surface of the protruding portions.

After the first-step vapor deposition, the angle α₂ between the surface of the negative electrode current collector and the horizontal direction was adjusted to 60° by moving the fixture stand 44. Then, a second-step vapor deposition was carried out under the same conditions as those of the first-step vapor deposition. Further, a total of eight vapor deposition steps were carried out by alternating the angle between the surface of the negative electrode current collector and the horizontal direction such that vapor depositions in the steps of odd numbers were carried out in the same manner as the first-step vapor deposition and vapor depositions in the steps of even numbers were carried out in the same manner as the second-step vapor deposition.

In this manner, alloy-based negative electrode active material layers having a composition represented by SiOₓ (x=1.2) were formed on both surfaces of the negative electrode current collector. Thus, a negative electrode A1 was obtained. When the negative electrode A1 immediately after vapor deposition was observed with an SEM, columnar bodies having a height of about 20 μm, each of the columnar bodies being supported on each of the protruding portions, and bumps having a height of about 5.5 μm in which middle portions were raising were formed, each of the bumps being supported on each of the flat portions, as illustrated in FIG. 2. The columnar bodies had a roughly spindle shape in which the upper side was more swelling than the central portion, and the diameter of the swelling portion was about 25 μm. The height of the bumps was lower than the height of positions in which the adjacent columnar bodies were closest to each other.

### (3) Production of Positive Electrode

A positive electrode material mixture paste was prepared by mixing 100 parts by mass of lithium cobaltate (LiCoO₂) having an average particle diameter of 5 μm, 3 parts by mass of acetylene black, 4 parts by mass of polyvinylidene fluoride (PVdF), and a predetermined amount of dispersing medium (N-methyl-2-pyrrolidone). This positive electrode material mixture paste was applied onto one surface of a positive electrode current collector composed of an aluminum foil having a thickness of 15 μm, which was then dried to form a positive electrode active material layer. Then, the positive electrode active material layer was rolled into a thickness of 85 μm, thereby producing a positive electrode.

### (4) Production of Laminate Type Lithium Ion Secondary Battery

An electrode group was produced by laminating the negative electrode, the positive electrode, and a separator interposed between the negative electrode A1 and the positive electrode. As the separator, a microporous film made of polyethylene (trade name: High Pore, thickness 20 μm, available from Asahi Kasei Corporation) was used. Next, an end of a negative electrode lead made of nickel on which a tab for a gasket made of polypropylene was formed was welded to a lead fixing portion of the negative electrode A1. Meanwhile, an end of a positive electrode lead made of aluminum on which a tab for a gasket made of polypropylene was formed was welded to a lead fixing portion of the positive electrode. Then, the electrode group was housed in an outer case composed of an aluminum laminate sheet. Further, an electrolyte was poured into the outer case. As the electrolyte, a non-aqueous electrolyte prepared by dissolving LiPF₆ at a concentration of 1 mol/L in a solvent mixture including ethylene carbonate, ethylmethyl carbonate, and diethyl carbonate in a volume ratio of 3:5:2 was used.

Then, opening portions of the outer case were welded in the state where the negative electrode lead and the positive electrode lead were lead outside from the respective openings of the outer case. Thus, a laminate type lithium ion secondary battery A was produced.

### (5) Evaluation of Negative Electrode and Lithium Ion Secondary Battery

(Percentage of sectional area of bump in sectional area of space B defined by line segment connecting positions in which two columnar bodies are the closest, surface of flat portion, and side surfaces of columnar bodies)

The battery A was left in a constant temperature oven at 20° C. for a predetermined time. Then, a constant current charge was carried out at a charge rate of 1 C until the voltage between the two electrodes reached 4.2 V. After the voltage between the two electrodes reached 4.2 V, a constant voltage charge was carried out until the current value reached 0.05 C. Subsequently, the battery A after the charge was discharged at a constant current at a discharge rate of 0.2 C until the voltage between the two electrodes reached 2.5 V, which brought the battery A in the initial discharged state.

Thereafter, the negative electrode A1 was removed from the battery A in the initial discharged state. Then, the state of the surface and the cross section of the negative electrode A1 in the initial discharged state was observed with an SEM. The height of the columnar bodies was 23 μm on average and the height of the bumps was 6 μm on average in the initial discharged state. Consequently, the height of the bumps in the initial discharged state was about 26% of the height of the columnar bodies. Also, the height of the middle portions of the bumps in the initial discharged state was about 2.5 times as high as the height of the end portions of the bumps.

The height of the bumps was lower than the height of the positions in which the adjacent columnar bodies are the closest to each other and existed in the space formed between the adjacent columnar bodies. Also, in the discharged state, the columnar bodies and the bumps were not in contact with each other.

Then, in an SEM image, as shown in FIGS. 1 and 2, the sectional area of the space B defined by the line segment connecting positions in which two adjacent columnar bodies are the closest to each other, the surface of the flat portions, and the side surfaces of the columnar bodies, was determined, and also the sectional area of the bumps was determined. Then, the percentage of the sectional area of the bumps in the sectional area of the space B was determined. The percentage of the sectional area of the bumps in the sectional area of the space B was determined by number averaging data measured at five points selected evenly. As a result, the sectional area of the bumps relative to the sectional area of the space B of the negative electrode A1 was 60% on average.

The negative electrode A1 was removed from the battery A in the charged state and the state of the cross section thereof was observed with an SEM, and it was found that the columnar bodies and the bumps were expanded significantly. Then, the adjacent columnar bodies were in contact with each other, and the top portions of the bumps expanded in the space formed between the adjacent columnar bodies were in contact with the lower portions of the adjacent columnar bodies so as to support the lower portions of the adjacent columnar bodies.

### (Evaluation of Cycle Capacity Maintenance Ratio)

The battery A in the initial discharged state was charged at a constant current at a charge rate of 1 C until the voltage between the two electrodes reached 4.2 V. After the voltage between the two electrodes reached 4.2 V, a constant voltage charge was carried out until the current value reached 0.05 C. Then, after the charge, the rest time was maintained for 20 minutes. Subsequently, the battery A after the charge was discharged at a constant current at a discharge rate of 0.2 C until the voltage between the two electrodes reached 2.5 V. This charge and discharge cycle was defined as one cycle and a total of 100 cycles were repeated. Then, a discharge capacity W₁ [mAh] at the first cycle and a discharge capacity W₁₀₀ [mAh] at the 100^{th} cycle were measured, and a cycle capacity maintenance ratio [%] was calculated by the formula: W₁₀₀/W₁×100. As a result, the cycle capacity maintenance ratio of the battery A was 90%. Hardly any cracks were observed in the columnar bodies and the bumps of the negative electrode A1 after the evaluation of the cycle capacity maintenance ratio.

### Example 2

A negative electrode B1 was produced in the same manner as in Example 1 except that, in “production of negative electrode (2)”, pressure after the supply of gas was adjusted to 1×10⁻² Pa (abs) in place of adjusting to 5×10⁻² Pa. Next, a battery B was produced in the same manner as in Example 1 except for using the negative electrode B1 in place of the negative electrode A1. Then, the negative electrode and the battery were evaluated in the same manner as in Example 1.

In the initial discharged state, the height of the columnar bodies was about 23 μm and the height of the bumps was about 3 μm, and the percentage of the height of the bumps relative to the height of the columnar bodies was about 13%. The sectional area of the bumps of the negative electrode B1 was 30% of the sectional area of the aforementioned space. The cycle capacity maintenance ratio of the battery B was 85%. Hardly any cracks were observed on the columnar bodies and the bumps of the negative electrode B1 after the evaluation of the cycle capacity maintenance ratio.

### Example 3

A negative electrode C1 was produced in the same manner as in Example 1 except that, in “production of negative electrode (2)”, pressure after the supply of gas was adjusted to 2×10⁻² Pa (abs) in place of adjusting to 5×10⁻² Pa. Next, a battery C was produced in the same manner as in Example 1 except for using the negative electrode C1 in place of the negative electrode A1. Then, the negative electrode and the battery were evaluated in the same manner as in Example 1.

In the initial discharged state, the height of the columnar bodies was about 23 μm and the height of the bumps was about 4.9 μm, and the percentage of the height of the bumps in the height of the columnar bodies was about 21%. The sectional area of the bumps of the negative electrode C1 was 40% of the sectional area of the aforementioned space. The cycle capacity maintenance ratio of the battery C was 87%. Hardly any cracks were observed in the columnar bodies and the bumps of the negative electrode C1 after the evaluation of the cycle capacity maintenance ratio.

### Comparative Example 1

A negative electrode D1 was produced in the same manner as in Example 1 except that, in “production of negative electrode (2)”, pressure after the supply of gas was adjusted to 8×10⁻³ Pa (abs) in place of adjusting to 5×10⁻² Pa (abs). Next, a battery D was produced in the same manner as in Example 1 except for using the negative electrode D1 in place of the negative electrode A1. Then, the negative electrode and the battery were evaluated in the same manner as in Example 1.

In the initial discharged state, the height of the columnar bodies was about 23 μm and the height of the bumps was about 2.6 μm, and the percentage of the height of the bumps relative to the height of the columnar bodies was about 11%. The sectional area of the bumps of the negative electrode D1 was 20% of the sectional area of the aforementioned space. The cycle capacity maintenance ratio of the battery C was 80%. The negative electrode D1 was removed from the battery D in the charged state and the state of the cross section thereof was observed with an SEM, and it was found that both the columnar bodies and the bumps were expanded. Although the adjacent columnar bodies were in contact with each other, the columnar bodies and the top portions of the bumps were hardly in contact with each other. Also, cracks were observed on the columnar bodies. These cracks are considered to have been formed because the columnar bodies expanded excessively on account of internal stress produced in the columnar bodies.

From the above results, it is found that growth of the coating film of the alloy-based negative electrode active material on the flat portions can be adjusted by adjusting the degree of decompression in the vacuum chamber 41 during vapor deposition of the alloy-based negative electrode active material. The present inventors consider that this phenomenon is due to the fact that mobility of vaporized silicon atoms etc. is changed and thus the amount of raw material gas penetrating the space formed between the protruding portions is changed by adjusting the degree of decompression during vapor deposition.

Also, it is found that the cycle capacity maintenance ratio is improved greatly by forming the predetermined bumps and distributing stress in the active material.

### INDUSTRIAL APPLICABILITY

The negative electrode for a lithium ion secondary battery of the present invention is useful as a negative electrode for providing a lithium ion secondary battery having a high charge and discharge capacity, which is a characteristic of the alloy-based active material, and having excellent charge and discharge cycle characteristics. Further, the negative electrode for a lithium ion secondary battery of the present invention is also applicable to the use of a negative electrode in a lithium ion capacitor.

### REFERENCE SIGNS LIST

1 Negative electrode current collector
1a Protruding portions
1b Flat portions
2 Negative electrode active material layer
2a Columnar bodies
2b Bumps
2c End portions
10 Negative electrode for lithium ion secondary battery
11 Laminate type lithium ion secondary battery
12 Positive electrode
13 Separator
14 Outer case
17 Positive electrode current collector
18 Positive electrode active material layer
19 Negative electrode lead
20 Positive electrode lead
21 Opening portions
22 Gaskets
40 Vapor deposition apparatus
41 Vacuum chamber
43 Nozzle
44 Fixture stand
45 Target
50 Raw material atom
51 Inert gas
A Line segment
B Space
H1 Height of columnar bodies 2a
H2 Height of bumps 2b
H3 Height of protruding portions 1a

1. A negative electrode for a lithium ion secondary battery, comprising:
a current collector sheet and a negative electrode active material layer supported on said current collector sheet;
said current collector sheet including a surface that comprises a plurality of protruding portions arranged according to a pattern having regular intervals and a plurality of flat portions existing between said plurality of protruding portions,
wherein said negative electrode active material layer includes a plurality of columnar bodies having a roughly spindle shape, each of said columnar bodies supported on each of said protruding portions, and a plurality of bumps, each of said bumps supported on each of said flat portions, said columnar bodies and said bumps comprising an alloy-based negative electrode active material,
said bumps have a height lower than a height of a position in which said columnar bodies adjacent to each other are the closest to each other, and
in a discharged state of the lithium ion secondary battery, in a vertical cross section made by supposedly cutting from a supposed straight line passing through each center of two adjacent said columnar bodies and a center of said bump sandwiched between said two columnar bodies when viewed on an upper surface toward a surface of said current collector sheet, a sectional area of said bump accounts for 25% or more, on average, of a sectional area of a space defined by a line segment connecting positions in which said two adjacent columnar bodies are the closest to each other, a surface of said flat portion, and two side surfaces of said columnar bodies.

2. The negative electrode for a lithium ion secondary battery in accordance with claim 1, wherein said bumps have a height of 3 to 6 μm in said discharged state.

3. The negative electrode for a lithium ion secondary battery in accordance with claim 1, wherein said columnar bodies are not in contact with upper portions of said bumps in said discharged state, and lower portions of said columnar bodies are in contact with upper portions of said bumps in a charged state.

4. The negative electrode for a lithium ion secondary battery in accordance with claim 1, wherein in said discharged state, middle portions of said bumps are raising more than peripheries of said bumps, and top portions of said middle portions are 1.3 times or more as high as end portions of said peripheries.

5. The negative electrode for a lithium ion secondary battery in accordance with claim 1, wherein said columnar bodies have a roughly spindle shape in which upper side is swelling more than central portion.

6. The negative electrode for a lithium ion secondary battery in accordance with claim 1, wherein in said discharged state, said columnar bodies have a height of 20 to 30 μm.

7. The negative electrode for a lithium ion secondary battery in accordance with claim 1, wherein in said discharged state, the height of said bumps is 10 to 30% of the height of said columnar bodies.

8. The negative electrode for a lithium ion secondary battery in accordance with claim 1, wherein said columnar bodies are laminates comprising said alloy-based negative electrode active material.

9. The negative electrode for a lithium ion secondary battery in accordance with claim 1, wherein said protruding portions have a height of 3 to 15 μm.

10. The negative electrode for a lithium ion secondary battery in accordance with claim 1, wherein said pattern having regular intervals is in a zigzag alignment.

11. The negative electrode for a lithium ion secondary battery in accordance with claim 1, wherein a surface area of said flat portions accounts for 30 to 50% of a surface area of said current collector sheet.

12. The negative electrode for a lithium ion secondary battery in accordance with claim 1, wherein in said discharged state, said negative electrode active material layer has a porosity of 20 to 70%.

13. The negative electrode for a lithium ion secondary battery in accordance with claim 1, wherein said discharged state is a discharged state in an initial charge and discharge period of the lithium ion secondary battery.

14. A lithium ion secondary battery comprising: the negative electrode in accordance with claim 1; a positive electrode absorbing and desorbing lithium ions; a separator separating said negative electrode and said positive electrode; and an electrolyte having a lithium ion conductivity.
